(19) United States
(12) Patent Application Publication
(10) Pub. No.: US 2013/0066634 A1
(43) Pub. Date: Mar. 14, 2013

(54) Automated Conversation Assistance

(71) Applicants: Samir S. Soliman, San Diego, CA (US); Soham V. Sheth, San Diego, CA (US); Vijayalakshmi R. Raveendran, San Diego, CA (US)

(72) Inventors: Samir S. Soliman, San Diego, CA (US); Soham V. Sheth, San Diego, CA (US); Vijayalakshmi R. Raveendran, San Diego, CA (US)

(73) Assignee: QUALCOMM Incorporated, San Diego, CA (US)

(21) Appl. No.: 13/419,056

(22) Filed: Mar. 13, 2012

Related U.S. Application Data
(60) Provisional application No. 61/453,532, filed on Mar. 16, 2011.
(60) Provisional application No. 61/569,068, filed on Dec. 9, 2011.

(51) Int. Cl. G10L 21/00

(52) U.S. Cl. 704/270.1; 704/E21.001

(57) ABSTRACT

Methods, apparatuses, systems, and computer-readable media for providing automated conversation assistance are presented. According to one or more aspects, a computing device may obtain user profile information associated with a user of the computing device, the user profile information including a list of one or more words that have previously been detected in one or more previously captured speeches associated with the user. Subsequently, the computing device may select, based on the user profile information, one or more words from a captured speech for inclusion in a search query. Then, the computing device may generate the search query based on the selected one or more words.

### CROSS-REFERENCE TO RELATED APPLICATIONS

This patent application claims the benefit of U.S. Provisional Patent Application Ser. No. 61/453,532, filed Mar. 16, 2011, and entitled “Mobile Device Acting As Automated Information Assistant During Audio Processing,” and of U.S. Provisional Patent Application Ser. No. 61/569,068, filed Dec. 9, 2011, and entitled “Automated Conversation Assistance,” which are incorporated by reference herein in their entireties for all purposes.

### BACKGROUND

Aspects of the disclosure relate to computing technologies. In particular, aspects of the disclosure relate to mobile computing device technologies, such as systems, methods, apparatuses, and computer-readable media for providing automated conversation assistance.

Some current systems may provide speech-to-text functionalities and/or may allow users to perform searches (e.g., Internet searches) based on captured audio. These current systems are often limited, however, such as in the extent to which they may accept search words and phrases, as well as in the degree to which a user might need to manually select and/or edit search words and phrases and/or other information that is to be searched. Aspects of the disclosure provide more convenience and functionality to users of computing devices, such as mobile computing devices, by implementing enhanced speech-to-text functionalities in combination with intelligent content searching to provide automated conversation assistance.

### SUMMARY

Systems, methods, apparatuses, and computer-readable media for providing automated conversation assistance are presented. As noted above, while some current systems may provide speech-to-text functionalities and/or allow users to perform searches (e.g., Internet searches) based on captured audio, these current technologies are limited in that such searches are restricted to single words or short phrases that are captured. Indeed, if audio associated with a longer speech were captured by one of these current systems, a user might have to manually specify which words and/or phrases are to be searched.

By implementing aspects of the disclosure, however, a device not only may capture a longer speech (e.g., a telephone call, a live presentation, a face-to-face or in-person discussion, a radio program, an audio portion of a television program, etc.), but also may intelligently select words from the speech to be searched, so as to provide a user with relevant information about one or more topics discussed in the speech. Advantageously, these features and/or other features described herein may provide increased functionality and improved convenience to users of mobile devices and/or other computing devices. Additionally or alternatively, these features and/or other features described herein may increase and/or otherwise enhance the amount and/or quality of the information absorbed by the user from the captured speech.

According to one or more aspects of the disclosure, a computing device may obtain user profile information associated with a user of the computing device, and the user profile information may include a list of one or more words that have previously been detected in one or more previously captured speeches associated with the user. Subsequently, the computing device may select, based on the user profile information, one or more words from a captured speech for inclusion in a search query. Then, the computing device may generate the search query based on the selected one or more words.

In one or more arrangements, prior to selecting one or more words, the computing device may receive audio data corresponding to the captured speech, and the audio data may be associated with one of a telephone call, a live presentation, a face-to-face discussion, a radio program, and a television program. In other arrangements, the user profile information may further include a list of one or more words that have previously been searched by the user.

In at least one arrangement, the computing device may add at least one word from the captured speech to the list of one or more words that have previously been detected in one or more previous captured speeches. In this manner, a database of previously encountered, detected, and/or searched words may be built, for instance, over a period of time. Advantageously, this may enable the computing device to more intelligently select words to be searched, such that information previously encountered, detected, and/or searched (and which, for instance, the user may accordingly be familiar with) might not be searched again, while information that is new and/or has not been previously encountered, detected, and/or searched (and which, for instance, the user may accordingly be unfamiliar with) may be searched and/or prioritized over other information (e.g., by being displayed more prominently than such other information).

In one or more additional and/or alternative arrangements, the user profile information may include information about a user's occupation, education, or interests. In some arrangements, the computing device may select one or more words further based on one or more words that have previously been searched by one or more other users having profile information similar to the user profile information. For example, a list of keywords may define one or more words in which users having similar profile information are interested, and the list of keywords may be used in generating and determining to execute search queries, as discussed below. Additionally or alternatively, an exclusion list may define one or more words in which certain users (e.g., certain users having similar profile information) are not interested, and the exclusion list may be used in generating search queries and/or determining to execute search queries, as also discussed below.

In at least one additional and/or alternative arrangement, in response to generating the search query, the computing device may execute the search query. Subsequently, the computing device may cause results of the search query to be displayed to the user, and the results may include information about at least one topic included in the captured speech. Additionally or alternatively, the results may be displayed to the user in response to detecting that the captured speech has concluded. In other arrangements, the results may be displayed to the user in real-time (e.g., as the speech is captured). As discussed below, factors such as the number of words, phrases, sentences, and/or paragraphs captured may affect whether and/or how real-time results are displayed.

### BRIEF DESCRIPTION OF THE DRAWINGS

Aspects of the disclosure are illustrated by way of example. In the accompanying figures, like reference numbers indicate similar elements, and:

FIG. 1A illustrates an example system that implements one or more aspects of the disclosure.

FIG. 1B illustrates another example system that implements one or more aspects of the disclosure.

FIG. 2A illustrates an example method of providing automated conversation assistance according to one or more illustrative aspects of the disclosure.

FIG. 2B illustrates an example method of selecting one or more words for inclusion in a search query according to one or more illustrative aspects of the disclosure.

FIGS. 3A, 3B, 3C, and 3D illustrate examples of content data sets according to one or more illustrative aspects of the disclosure.

FIG. 4 illustrates an example of a user profile according to one or more illustrative aspects of the disclosure.

FIG. 5 illustrates an example computing system in which one or more aspects of the disclosure may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

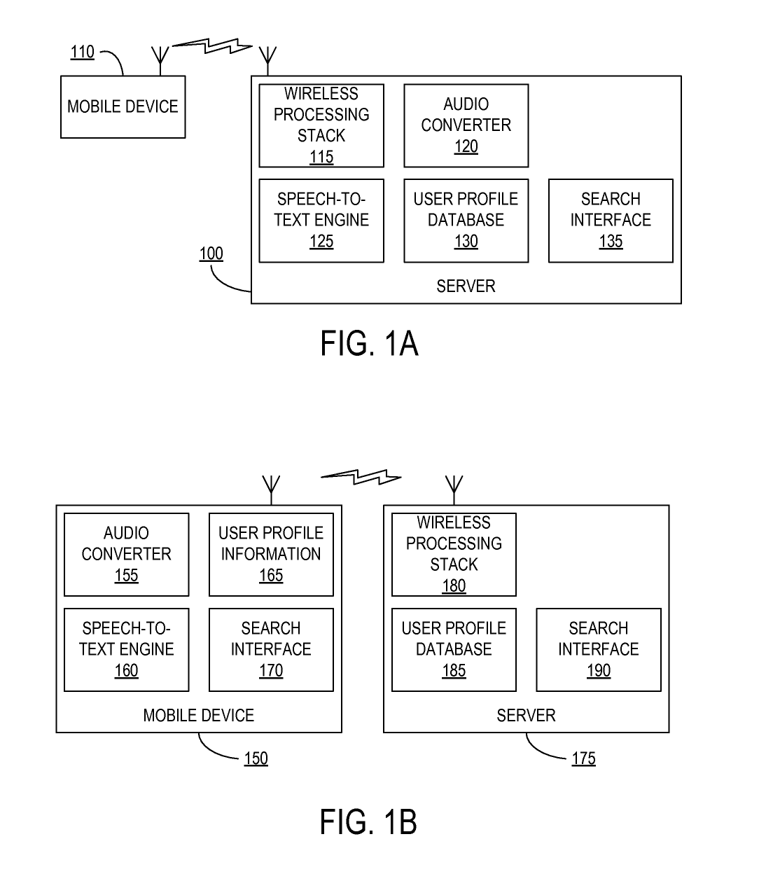

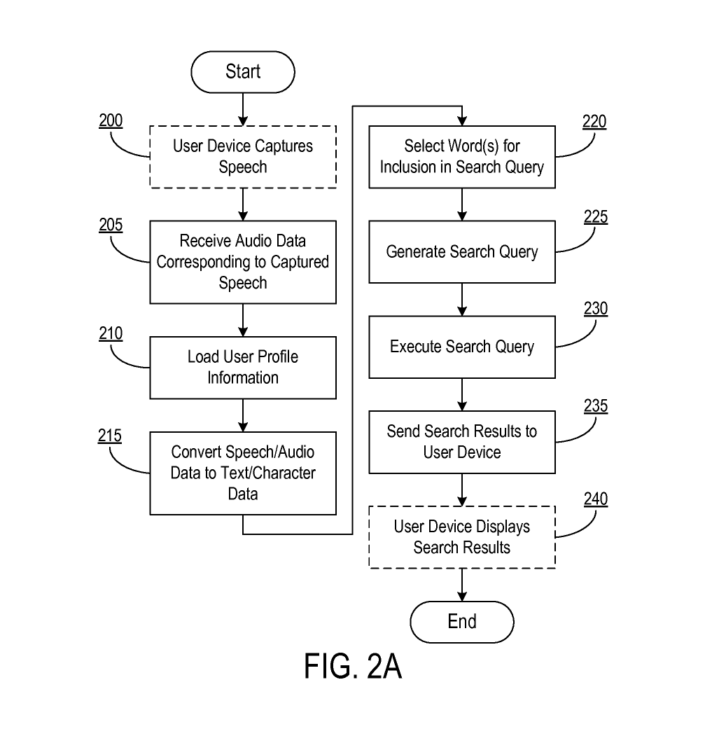

An example system that implements various aspects of the disclosure is illustrated in FIG. 1A. As seen in FIG. 1A, a user device 110, which may be a mobile computing device, may be in communication with a server 100. The server 100 may include a wireless processing stack 115, which may facilitate the provision of wireless communication services (e.g., by the server 100 to a plurality of mobile devices, including the user device 110). In addition, the server 100 may include an audio converter 120 and a speech-to-text engine 125, which together may operate to receive and convert audio data (e.g., audio data corresponding to a speech captured by the user device) into text and/or character data. The server 100 further may include a user profile database 130 (e.g., in which information associated with various users may be stored) and a search interface 135 (e.g., via which one or more Internet search queries may be executed, via which one or more database queries may be executed, etc.).

An alternative example of a system implementing one or more aspects of the disclosure is illustrated in FIG. 1B. As seen in FIG. 1B, in one or more additional and/or alternative arrangements, a mobile device 150 may include one or more components and/or modules that may operate alone or in combination so that the mobile device 150 may process and recognize speech and generate and execute search queries (e.g., as described in greater detail below) instead of relying on a server (e.g., server 100, server 175, etc.) to process and recognize speech and/or to generate and execute search queries. For example, the mobile device 150 may include an audio converter 155 and a speech-to-text engine 160 that may operate together to receive and convert audio data (e.g., audio data corresponding to a speech captured by the mobile device 150) into text and/or character data. The mobile device 150 further may include a user profile information module 165 (e.g., in which information about one or more users of the mobile device 150 may be stored) and a search interface 170 (e.g., via which one or more Internet search queries may be executed, via which one or more database queries may be executed, etc.). Additionally or alternatively, in some of these arrangements, a server may include any and/or all of the components and/or modules included in server 100 (e.g., so as to provide redundancy for the similar components and/or modules included in the mobile device 150), while in others of these arrangements, a server 175 might include only a wireless processing stack 180 (e.g., to facilitate the provision of wireless communication services to a plurality of devices), a user profile information database 185 (e.g., in which information about one or more users of the mobile device 150 and/or other similar devices may be stored), and/or a search interface 190 (e.g., which may execute and/or assist one or more mobile devices in executing one or more Internet search queries, one or more database queries, etc.). As noted above, in these arrangements, the user devices themselves, such as mobile device 150, might recognize speech and generate search queries instead of the server 175.

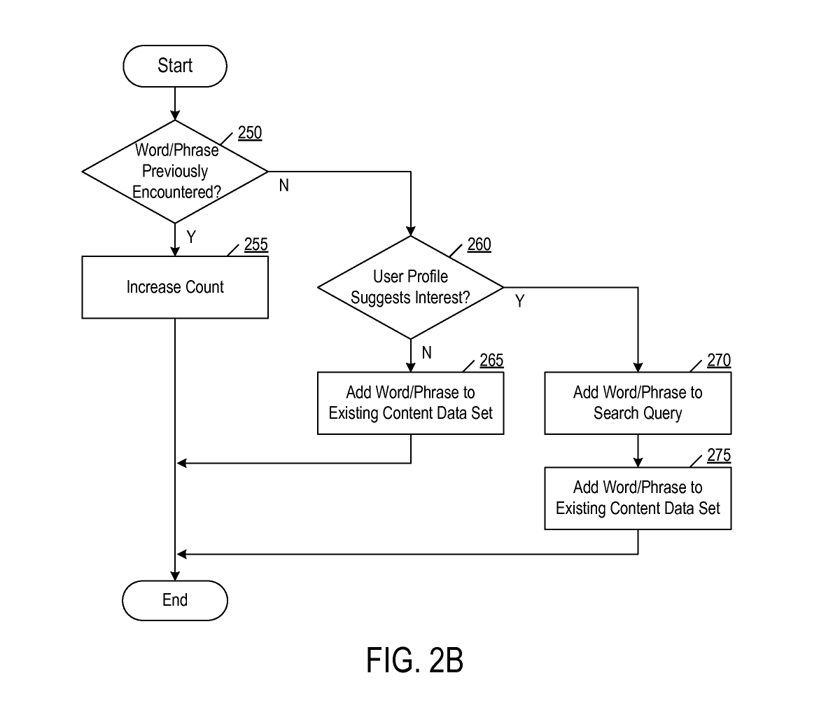

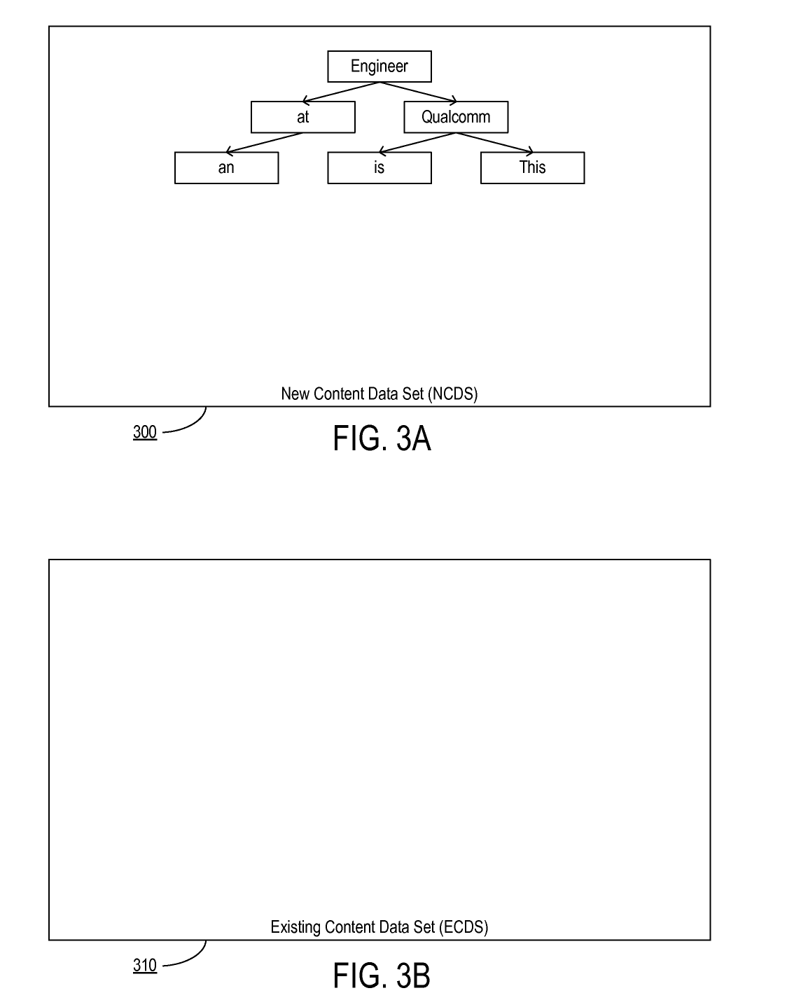

According to one or more aspects of the disclosure, one or more elements of the example system of FIG. 1A and/or FIG. 1B may perform any and/or all of the steps of the example method illustrated in FIG. 2A in providing automated conversation assistance. For example, in step 200, the user device 110 (e.g., a mobile device, such as a smart phone, tablet computer, personal digital assistant, etc.) may capture a speech (e.g., by recording audio data representing the speech via a microphone).

Subsequently, the user device 110 may transmit, and the server 100 may receive, in step 205, the audio data corresponding to the captured speech.

While in several of the steps that follow, the server 100 of FIG. 1A is described as performing various steps, in one or more additional and/or alternative embodiments (e.g., embodiments in which the mobile device 150, rather than the server 100, processes and recognized speech and generates and executes search queries), the same and/or similar steps may be performed by the mobile device 150 of FIG. 1B.

Once the server 100 receives the audio data, the server 100 may load user profile information (e.g., user profile information associated with a user of the user device 110 that captured the speech) in step 210. In one or more arrangements, the user profile information may include a list of words that have previously been searched (e.g., words that were searched by the user during previous iterations of the method). Additionally or alternatively, the user profile information may include information about the user's occupation, education, or interests.

As noted above, the user profile information loaded in step 210 may include information associated with the user (e.g., information about the user of the user device 110) that includes a list of one or more words that have previously been detected in one or more previously captured speeches associated with the user, such as words that have previously been encountered by the user and/or identified by and/or otherwise captured by user device 110 (and/or server 100 in analyzing speeches involving the user). For example, if the user had previously heard (and the user device 110 had previously captured audio corresponding to) the sentence “This is an engineer at Qualcomm,” then each of the words included in the phrase and/or the entire phrase itself may be stored in the list of words that have previously been detected in captured speeches. Subsequently, if the user were to again encounter this phrase (such that the device would again detect this phrase), the device would be able to determine, based on the user profile information associated with the user, that the user has previously encountered the phrase and all of the words included in it, and thus might not include the phrase (or any of the words included in the phrase) in forming a subsequent search query. Additional factors, such as whether any of the captured words are included in a list of keywords associated with the user profile and/or an exclusion list associated with the user profile also may be taken in account, as discussed below.

Next, in step 215, the server 100 may convert the audio data (and specifically, the speech included in the audio data) into text and/or character data (e.g., one or more strings). Subsequently, in step 220, the server 100 may select one or more words (e.g., from the converted audio data) to be included in a search query. In particular, the server 100 may select words based on the user profile information, such that the search query is adapted to the particular user's background and knowledge, for instance. In one arrangement, for example, the server 100 may select words for inclusion in the search query based on words that have been searched by other users who have similar profile information as the user (e.g., other users with the same occupation, education, or interests as the user). In one or more arrangements, the server 100 may, in step 220, select one or more words for inclusion in the search query by performing one or more steps of the example method illustrated in FIG. 2B, which is described in greater detail below.

Referring again to FIG. 2A, having selected one or more words for inclusion in the search query, the server 100 then, in step 225, may generate the search query (e.g., by stringing together the selected words using one or more conjunctions and/or other search modifiers). Next, in step 230, the server 100 may execute the search query (e.g., by passing the search query to an Internet search engine, news and/or journal search interface, and/or the like). Once the server 100 receives the results of the executed search query, the server 100 may, in step 235, send the search results to the user device 110, which in turn may display the search results to the user in step 240. According to one or more aspects, the search results may include more detailed information about at least one topic included in the captured speech, such as the definition of a word or phrase that the user might not be familiar with, a journal article explaining technical concepts raised in the speech that the user might not have been exposed to before, and/or the like.

In one or more arrangements, the generation and execution of the search query may be performed in real-time (e.g., as the captured speech is occurring and/or being captured by the user device 110), and the server 100 may likewise deliver search results to the user device 110 as such search results are received. In at least one arrangement, however, the user device 110 might be configured to wait to display any such search results until the user device 110 detects that the speech being captured has ended (e.g., based on a period of silence that exceeds a certain threshold and/or based on other indicators, such as the detection of farewell words, like “goodbye” or “take care,” in the case of a face-to-face discussion or telephone call or the detection of applause in the case of a live presentation).

In arrangements in which the generation and execution of the search query is performed in real-time (e.g., by the server 100 or by mobile device 150), determining when (e.g., at which particular point during the captured speech) a search query should be generated and executed may depend upon the length and/or nature of the captured speech. For example, in some arrangements in which a search query is generated and executed in real-time, the server 100 or mobile device 150 may be configured to automatically generate and execute a search query (e.g., using one or more selected words, as discussed below with respect to FIG. 2B) after a threshold number of words, phrases, sentences, or paragraphs have been captured. For instance, the server 100 or mobile device 150 may be configured to automatically generate and execute a search query using selected words of the captured words whenever a full sentence has been captured, whenever two full sentences have been captured, whenever a full paragraph has been captured, and/or the like. In other arrangements in which a search query is generated and executed in real-time, the server 100 or mobile device 150 may be configured to automatically generate and execute a search query whenever a new concept (e.g., a new type of technology) is included in the captured speech, as this may represent a shift in the conversation or speech being captured and thus may be a point at which the user may desire to view search results.

In still other arrangements in which a search query is generated and executed in real-time, the server 100 or mobile device 150 may be configured to automatically generate and execute a search query depending on a user-defined and/or predefined priority level associated with a detected word or phrase. For example, some words may be considered to have a “high” priority, such that if such words are detected, a search based on the words is generated and executed immediately, while other words may be considered to have a “normal” priority, such that if such words are detected, a search based on the words is generated and executed within a predetermined amount of time (e.g., within thirty seconds, within one minute, etc.) and/or after a threshold number of words and/or phrases (e.g., after two additional sentences have been captured, after two paragraphs have been captured, etc.). Additionally or alternatively, different words may be considered “high” priority and “normal” priority for different types of users, as based on the different user profile information of the different users. Examples of the different types of priority levels associated with different words for different types of users are illustrated in the table below:

TABLE A

| Profile Type | Real-Time Search Word(s) | Priority |
|---|---|---|
| Wireless Engineer | Voice-Over-LTE | High |
| Wireless Engineer | CDMA | Normal |
| Corporate Finance | Current Share Price | High |
| Corporate Finance | Proposed Tax Code | Normal |

FIG. 2B illustrates an example method of selecting one or more words for inclusion in a search query according to one or more illustrative aspects of the disclosure. According to one or more aspects of the disclosure, any and/or all of the methods and/or method steps described herein may be performed by a computing device and/or a computer system, such as computer system 500, which is described below. Additionally or alternatively, any and/or all of the methods and/or method steps described herein may be embodied in computer-readable instructions and/or computer-executable instructions, such as computer-readable instructions stored in the memory of an apparatus, which may include one or more processors to execute such instructions, and/or as computer-readable instructions stored on one or more computer-readable media.

As discussed above, one or more steps of the example method illustrated in FIG. 2B may be performed by a server 100 in selecting one or more words for inclusion in a search query. Accordingly, in one or more arrangements, any and/or all of the steps of the example method illustrated in FIG. 2B may be performed by a server 100 after speech and/or audio data has been converted into text and/or character data, and/or before a search query has been generated and/or executed. In one or more additional and/or alternative arrangements, one or more steps of the example method illustrated in FIG. 2B may be performed by a mobile device 150 in selecting one or more words for inclusion in a search query. Thus, in these arrangements, any and/or all of the steps of the example method illustrated in FIG. 2B may be performed by a mobile device 150 after speech and/or audio data has been converted into text and/or character data, and/or before a search query has been generated and/or executed.

In step 250, it may be determined whether a particular word or phrase was previously encountered. For example, in step 250, server 100 may determine whether a particular word or phrase included in the text and/or character data (which may represent the captured audio data) has been previously encountered by the user of the user device 110. In an alternative example, in step 250, mobile device 150 may determine whether a particular word or phrase included in the text and/or character data (e.g., representing the captured audio data) has been previously encountered by the user of the mobile device 150. In one or more arrangements, server 100 or mobile device 150 may make this determination based on whether the particular word or phrase is included in a content data set maintained by and/or stored on server 100 or mobile device 150. In one or more arrangements, such a content data set may include, for instance, a listing of words and/or phrases previously encountered by the user, as well as additional information, such as how many times the user has encountered each of the words and/or phrases, how many times, if any, the user has searched for more information about each of the words and/or phrases, and/or other information. Additionally or alternatively, such a content data set may form all or part of the user profile information associated with the particular user of the user device 110 or mobile device 150. Furthermore, in some arrangements, multiple content data sets may be maintained for and/or otherwise correspond to a single user.

In at least one arrangement, because server 100 or mobile device 150 may receive words in real time as a speech or conversation is occurring and/or being captured by the user device 110 or mobile device 150, the particular word or phrase used by server 100 or mobile device 150 in the determination of step 250 may represent the most recently captured and/or converted word or phrase in the speech or conversation. Additionally or alternatively, server 100 or mobile device 150 may continuously execute the method of FIG. 2B (e.g., in a loop) until the captured speech and/or conversation concludes and/or until all of the words and/or phrases included in the captured speech and/or conversation have been processed by server 100 or mobile device 150.

If it is determined (e.g., by server 100 or mobile device 150), in step 250, that the word and/or phrase being evaluated by the server 100 or mobile device 150 has been previously encountered, then in step 255, the server 100 or mobile device 150 may increase a count value, which may represent the number of times that the particular word and/or phrase has been encountered by the user of the user device 110 or mobile device 150. In one or more arrangements, this count value may be stored in a content data set, for example.

On the other hand, if it is determined (e.g., by server 100 or mobile device 150), in step 250, that the word and/or phrase being evaluated by the server 100 or mobile device 150 has not been previously encountered, then in step 260, the server 100 or mobile device 150 may determine whether the user profile information associated with the user (e.g., the user profile information loaded by server 100 or mobile device 150 in step 210) suggests that the user may be interested in being presented with more information about the word and/or phrase. In one or more arrangements, the server 100 or mobile device 150 may make this determination based on whether other users with similar user profile information to the user (e.g., users with similar occupation, education, or interests as the user) have previously encountered and/or previously searched for more information associated with the word and/or phrase. Such information may be available to the server 100 or mobile device 150 by accessing a database in which user profile information and/or content data sets associated with other users may be stored, such as user profile database 130 or user profile database 185.

As new words are encountered, some of the new words may, for example, be considered to be “important” (e.g., by server 100 or mobile device 150) and accordingly may be determined to be words that the user is interested in (for inclusion in a search query), while other words might not be considered to be “important” and accordingly might not be determined to be words that the user is interested in. In at least one arrangement, whether a word is “important” or not may depend on whether the word is included in a list of keywords associated with the user's profile. Such a list may be user-defined (e.g., the user may add words to and/or remove words from the list) and/or may include one or more predetermined words based on the user's occupation, education, and/or interests (as well as other user profile information). Additionally or alternatively, such a list may be stored in connection with and/or otherwise be associated with the user's profile, such that the list may be loaded (e.g., by server 100 or mobile device 150) when the user profile information is loaded (e.g., in step 210 as described above). Examples of the keywords that may be associated with users of certain profiles are illustrated in the following table:

TABLE B

| Profile Type | Keyword(s) |
|---|---|
| Wireless Engineer | Signal Propagation |
| Wireless Engineer | Information Theory |
| Wireless Engineer | Computer Design |
| Corporate Finance | Discounted Cash Flow |
| Corporate Finance | Net Present Value |

In some arrangements, a word may be considered to be “important” if it is substantially related to a keyword associated with the user's profile. For example, if a particular user is associated with a “Wireless Engineer” profile and his device captures the phrase “Kennelly-Heaviside Layer,” the device may determine that this phrase is substantially related to the “Signal Propagation” keyword and accordingly may search for and/or display additional information about the Kennelly-Heaviside Layer, which is a layer of the Earth's ionosphere that affects radio signal propagation. A data table similar to the one illustrated above may be used to store words that are related to the keywords.

In one or more additional and/or alternative arrangements, in addition to a storing a list of keywords in association with a user's profile, a list of exclusion words also may be stored in association with the user's profile. Such an exclusion list may, for instance, define one or more that the user does not consider to be “important” and is not interested in receiving more information about. As with the list of keywords, the exclusion list may be user-defined and/or may include one or more predetermined words based on the user's occupation, education, and/or interests (as well as other user profile information). Additionally or alternatively, the exclusion list may be stored in connection with and/or otherwise be associated with the user's profile, such that the list may be loaded (e.g., by server 100 or mobile device 150) when the user profile information is loaded (e.g., in step 210 as described above). Examples of the keywords that may be associated with users of certain profiles are illustrated in the following table:

TABLE C

| Profile Type | Exclusion Word(s) |
|---|---|
| Wireless Engineer | TDMA |
| Wireless Engineer | GPRS |
| Corporate Finance | Capital Structure |
| Corporate Finance | Dividend |

If it is determined (e.g., by server 100 or mobile device 150), in step 260, that the user profile information associated with the user does not suggest that the user may be interested in being presented with more information about the word and/or phrase, then in step 265, the server 100 or mobile device 150 may add the word and/or phrase to an existing content data set associated with the user. In one or more arrangements, an existing content data set may include and/or otherwise represent words and/or phrases that the user has previously encountered and/or which the user might not be interested in having searched. Additionally or alternatively, the existing content data set may be one or more of the content data sets that are stored and/or otherwise maintained by server 100 or mobile device 150 with respect to the user, and are included in and/or form the user profile information associated with the user. Advantageously, by adding words and/or phrases to an existing content data set in this manner, server 100 or mobile device 150 may be less likely (if not entirely prevented) from selecting such words and/or phrases for inclusion in search queries in the future, thereby increasing the likelihood that future words and/or phrases that are searched by server 100 or mobile device 150 are words and/or phrases which the user might be genuinely interested in learning more information about.

On the other hand, if it is determined (e.g., by server 100 or mobile device 150), in step 260, that the user profile information associated with the user does suggest that the user may be interested in being presented with more information about the word and/or phrase, then in step 270, the server 100 or mobile device 150 may add the word and/or phrase to a search query (and/or to a list of words to be included in a search query that will be generated, for instance, by server 100 or mobile device 150 after the conclusion of the captured speech or conversation). Advantageously, by adding a word and/or phrase to the search query that the user has not previously encountered and that the user may be interested in (e.g., because other similar users also have been interested in the word and/or phrase), then the likelihood that the server 100 or mobile device 150 will provide the user with relevant and/or desirable search results may be increased.

Subsequently, in step 275, server 100 or mobile device 150 may add the word and/or phrase to an existing content data set associated with the user. In one or more arrangements, it may be desirable to add the word and/or phrase to an existing content data set after adding the word to the search query, as this may reduce the likelihood (if not entirely prevent) the word and/or phrase from being redundantly searched and/or otherwise presented again to the user in the future.

Thereafter, the method of FIG. 2B may end. As discussed above, however, in one or more arrangements, flow may return to the method of FIG. 2A, and the server 100 or mobile device 150 may proceed with generating and executing a search query (e.g., in step 225 and step 230, respectively) based on the words selected using the method of FIG. 2B.

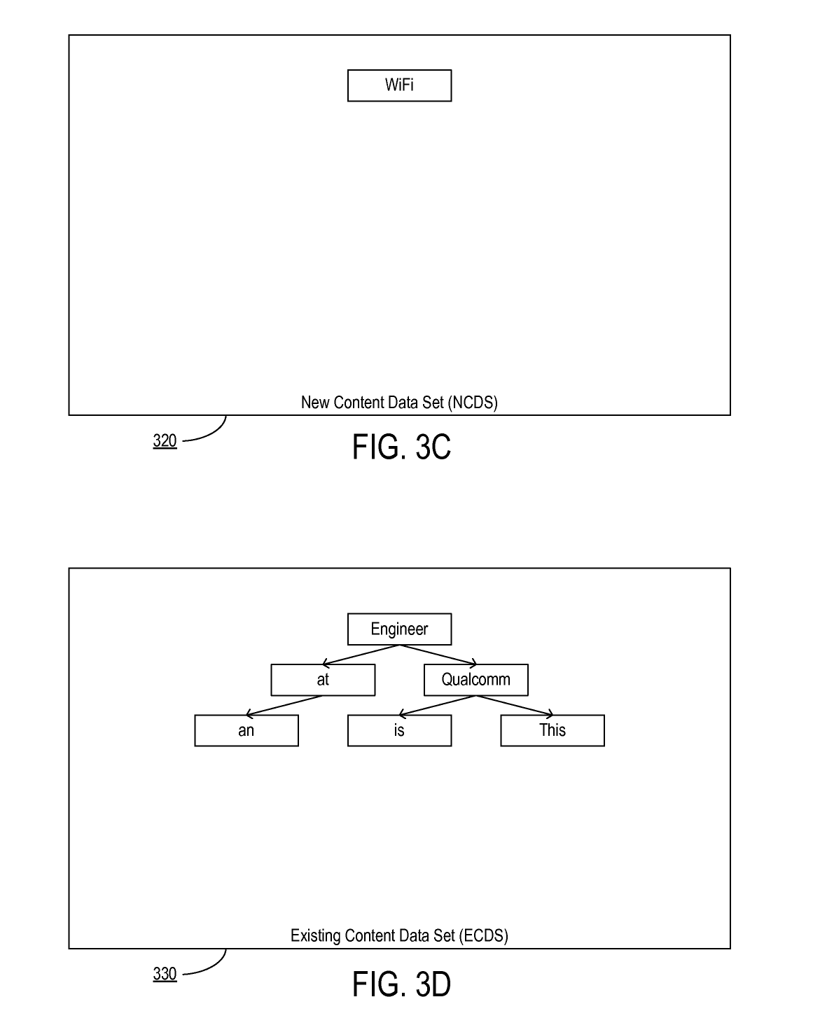

FIGS. 3A, 3B, 3C, and 3D illustrate examples of content data sets according to one or more illustrative aspects of the disclosure. As described above, a content data set may be part of a user's user profile information and may be used to track words and/or phrases that have been previously encountered and/or searched by the user. Additionally or alternatively, there may be two types of content data sets: (1) existing content data sets, in which words and/or phrases that have been previously encountered and/or searched by the user may be stored; and (2) new content data sets, in which captured words and/or phrases that have not been previously encountered and/or searched may be stored. In one or more arrangements, the words and/or phrases stored in a new content data set may remain in the new content data set temporarily, such that once the word and/or phrase has been searched, the particular word and/or phrase may be removed from the new content data set and instead added to an existing content data set. In this way, at a given point in time, a user may have both a new content data set and an existing content data set associated with their user profile information.

For example, FIGS. 3A and 3B illustrate a new content data set 300 and an existing content data set 310, respectively, at a first point in time. At this first point in time, the existing content data set 310 is empty, and the new content data set 300 has been created (e.g., by server 100) after the phrase “This is an Engineer at Qualcomm” has been captured by user device 110 and transmitted to the server 100, for instance.

At a later, second point in time, the phrase “This is an Engineer at Qualcomm” (and the words making up the phrase) may be removed from the new content data set and instead placed in the existing content data set, as illustrated in FIGS. 3C and 3D. For example, at the second point time, the phrase “This is a WiFi Engineer at Qualcomm” may be captured by user device 110 and transmitted to server 100, and accordingly, the new content data set 320, seen in FIG. 3C, might only include the word “WiFi,” whereas the existing content data set 330, seen in FIG. 3D, may include the other words in the phrase. In this example, if the server subsequently determines to perform a search of the captured words and/or phrases (e.g., based on determining that the user might be interested in the results of the search, as described above), then the server might only include the word “WiFi” in the search query, instead of including the phrase “This is a WiFi Engineer at Qualcomm” in the search query.

While the examples above discuss two content data sets (e.g., a new content data set and an existing content data set), in some arrangements, a single data set (or other database or data table) may be used, and new words might simply be marked with a “new” indicator within the data set for a predetermined amount of time after they are initially captured and recognized. Additionally or alternatively, such a data set (and/or the new content data set and the existing content data set described above) may include timestamp information indicating at what particular time(s) and/or date(s) each word included in the data set was captured. This data set may represent a detection history, for instance, and an example of such a data set is illustrated in the following table:

TABLE D

| Captured | | | |
|---|---|---|---|
| Word/Phrase | Timestamp(s) | Detection Count | New? |
| Single Radio Voice | February 2, 2012-8:30 | 1 | Yes |
| Call Continuity | AM PST | | |
| Femtocell | February 1, 2012- | 12 | No |
| | 12:30 PM PST [ . . . ] | | |
| LTE Advanced | February 1, 2012-9:00 | 2 | No |
| | PM PST [ . . . ] | | |

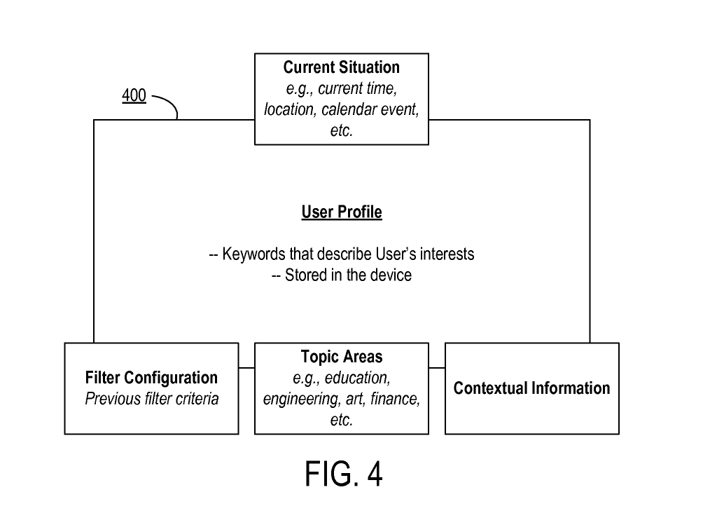

FIG. 4 illustrates an example of a user profile according to one or more illustrative aspects of the disclosure. As seen in FIG. 4, a user profile 400 may include various types of user profile information in addition to the types of user profile information described above. Any and/or all of this information may be taken into account (e.g., by server 100) when determining whether to perform a search, selecting words and/or phrases for inclusion in a search query, executing a search query, and/or displaying results of a search to a user. In one or more arrangements, a user profile 400 may include, for example, keywords that describe and/or are otherwise associated with a particular user's interests, as well as other keywords that may be stored by the user in their user device (e.g., user device 110). Additionally or alternatively, a user profile 400 may include information about the current situation of a user and/or the user's device (e.g., user device 110), such as the current time, the current location of the user and/or the user device, an event that the user might be attending (e.g., as determined based on the user's electronic calendar information), and so on.

In one or more arrangements, a user profile 400 further may include filter configuration information, which may comprise previously used filter criteria, such as filter criteria that a user might have used in filtering and/or otherwise sorting past search results. Additionally or alternatively, a user profile 400 may include information about particular topics and/or areas of interest of the user (e.g., engineering, art, finance, etc.), and/or contextual information about the user, the user device (e.g., user device 110), and/or the type of information sought by the user. By accounting for these different factors of a user profile, server 100 may provide enhanced functionality and convenience to the user.

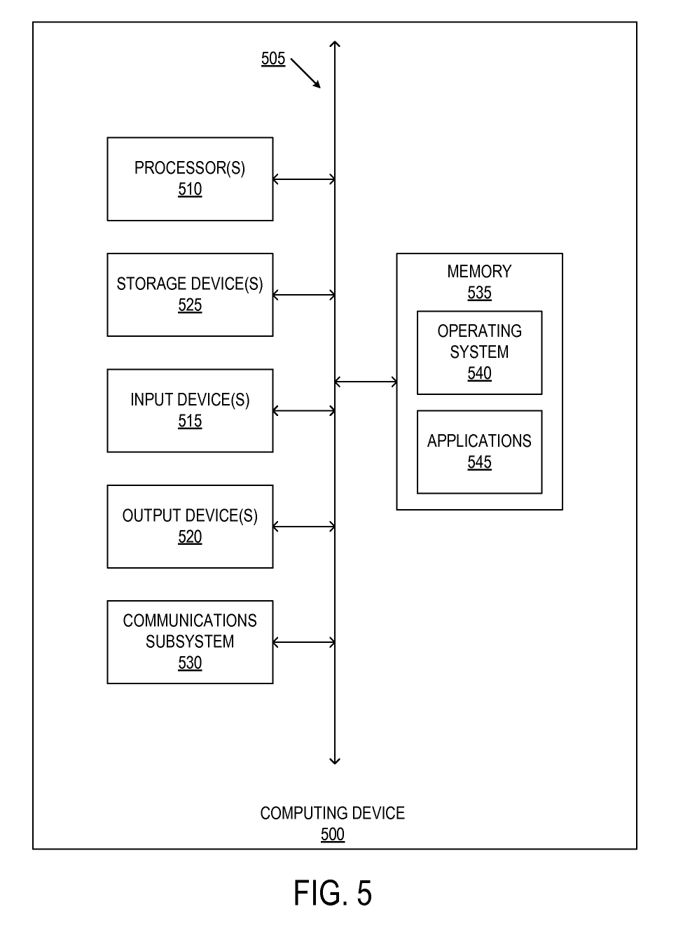

Having described multiple aspects of automated conversation assistance, an example of a computing system in which various aspects of the disclosure may be implemented will now be described with respect to FIG. 5. According to one or more aspects, a computer system as illustrated in FIG. 5 may be incorporated as part of a computing device, which may implement, perform, and/or execute any and/or all of the features, methods, and/or method steps described herein. For example, computer system 500 may represent some of the components of a hand-held device. A hand-held device may be any computing device with an input sensory unit, such as a camera and/or a display unit. Examples of a hand-held device include but are not limited to video game consoles, tablets, smart phones, and mobile devices. In one embodiment, the system 500 is configured to implement the server 100 and/or the user device 110 described above. FIG. 5 provides a schematic illustration of one embodiment of a computer system 500 that can perform the methods provided by various other embodiments, as described herein, and/or can function as the host computer system, a remote kiosk/terminal, a point-of-sale device, a mobile device, a set-top box, and/or a computer system. FIG. 5 is meant only to provide a generalized illustration of various components, any and/or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, and/or the like); one or more input devices 515, which can include without limitation a camera, a mouse, a keyboard and/or the like; and one or more output devices 520, which can include without limitation a display unit, a printer and/or the like.

The computer system 500 may further include (and/or be in communication with) one or more non-transitory storage devices 525, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 500 might also include a communications subsystem 530, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 530 may permit data to be exchanged with a network (such as the network described below, to name one example), other computer systems, and/or any other devices described herein. In many embodiments, the computer system 500 will further comprise a non-transitory working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIG. 2A and/or FIG. 2B, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 525 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 500) to perform methods in accordance with the disclosure. For example, some or all of the procedures of the described methods may be performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein, for example a method described with respect to FIG. 2A and/or FIG. 2B.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 525. Volatile media include, without limitation, dynamic memory, such as the working memory 535. Transmission media include, without limitation, coaxial cables, copper wire and fiber optics, including the wires that comprise the bus 505, as well as the various components of the communications subsystem 530 (and/or the media by which the communications subsystem 530 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 510 retrieves and executes the instructions. The instructions received by the working memory 535 may optionally be stored on a non-transitory storage device 525 either before or after execution by the processor(s) 510.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method comprising:
obtaining user profile information associated with a user, the user profile information including a list of one or more words that have previously been detected in one or more previously captured speeches associated with the user;
selecting, based on the user profile information, one or more words from a captured speech for inclusion in a search query; and
generating the search query based on the selected one or more words.

2. The method of claim 1, further comprising:
prior to selecting one or more words, receiving audio data corresponding to the captured speech,
wherein the audio data is associated with one of a telephone call, a live presentation, a face-to-face discussion, a radio program, and a television program.

3. The method of claim 1, wherein the user profile information further includes a list of one or more words that have previously been searched by the user.

4. The method of claim 1, further comprising:
adding at least one word from the captured speech to the list of one or more words that have previously been detected in one or more previous captured speeches.

5. The method of claim 1, wherein the user profile information includes information about a user's occupation, education, or interests.

6. The method of claim 5, wherein selecting one or more words is also based on one or more words that have previously been searched by one or more other users having profile information similar to the user profile information.

7. The method of claim 1, further comprising:
in response to generating the search query, executing the search query; and
causing results of the search query to be displayed to the user,
wherein the results include information about at least one topic included in the captured speech.

8. The method of claim 7, wherein the results are displayed to the user in response to detecting that the captured speech has concluded.

9. At least one computer-readable medium storing computer-readable instructions that, when executed, cause at least one computing device to:
obtain user profile information associated with a user, the user profile information including a list of one or more words that have previously been detected in one or more previously captured speeches associated with the user;
select, based on the user profile information, one or more words from a captured speech for inclusion in a search query; and
generate the search query based on the selected one or more words.

10. The at least one computer-readable medium of claim 9, having additional computer-readable instructions stored thereon that, when executed, further cause the at least one computing device to:
prior to selecting one or more words, receive audio data corresponding to the captured speech,
wherein the audio data is associated with one of a telephone call, a live presentation, a face-to-face discussion, a radio program, and a television program.

11. The at least one computer-readable medium of claim 9, wherein the user profile information further includes a list of one or more words that have previously been searched by the user.

12. The at least one computer-readable medium of claim 9, having additional computer-readable instructions stored thereon that, when executed, further cause the at least one computing device to:
add at least one word from the captured speech to the list of one or more words that have previously been detected in one or more previous captured speeches.

13. The at least one computer-readable medium of claim 9, wherein the user profile information includes information about a user's occupation, education, or interests.

14. The at least one computer-readable medium of claim 13, wherein selecting one or more words is also based on a list of keywords and an exclusion list that are defined based at least in part on one or more words that have previously been searched by one or more other users having profile information similar to the user profile information.

15. The at least one computer-readable medium of claim 9, having additional computer-readable instructions stored thereon that, when executed, further cause the at least one computing device to:
in response to generating the search query, execute the search query; and
cause results of the search query to be displayed to the user,
wherein the results include information about at least one topic included in the captured speech.

16. The at least one computer-readable medium of claim 15, wherein the results are displayed to the user in response to detecting that the captured speech has concluded.

17. An apparatus, comprising:
at least one processor; and
memory storing computer-readable instructions that, when executed by the at least one processor, cause the apparatus to:
obtain user profile information associated with a user, the user profile information including a list of one or more words that have previously been detected in one or more previously captured speeches associated with the user;
select, based on the user profile information, one or more words from a captured speech for inclusion in a search query; and
generate the search query based on the selected one or more words.

18. The apparatus of claim 17, wherein the memory stores additional computer-readable instructions that, when executed by the at least one processor, further cause the apparatus to:
prior to selecting one or more words, receive audio data corresponding to the captured speech,
wherein the audio data is associated with one of a telephone call, a live presentation, a face-to-face discussion, a radio program, and a television program.

19. The apparatus of claim 17, wherein the user profile information further includes a list of one or more words that have previously been searched by the user.

20. The apparatus of claim 17, wherein the memory stores additional computer-readable instructions that, when executed by the at least one processor, further cause the apparatus to:
add at least one word from the captured speech to the list of one or more words that have previously been detected in one or more previous captured speeches.

21. The apparatus of claim 17, wherein the user profile information includes information about a user's occupation, education, or interests.

22. The apparatus of claim 21, wherein selecting one or more words is also based on one or more words that have previously been searched by one or more other users having profile information similar to the user profile information.

23. The apparatus of claim 17, wherein the memory stores additional computer-readable instructions that, when executed by the at least one processor, further cause the apparatus to:
in response to generating the search query, execute the search query; and
cause results of the search query to be displayed to the user,
wherein the results include information about at least one topic included in the captured speech.

24. The apparatus of claim 23, wherein the results are displayed to the user in response to detecting that the captured speech has concluded.

25. A system comprising:
means for obtaining user profile information associated with a user, the user profile information including a list of one or more words that have previously been detected in one or more previously captured speeches associated with the user;
means for selecting, based on the user profile information, one or more words from a captured speech for inclusion in a search query; and
means for generating the search query based on the selected one or more words.

26. The system of claim 25, further comprising:
means for receiving, prior to selecting one or more words, audio data corresponding to the captured speech,
wherein the audio data is associated with one of a telephone call, a live presentation, a face-to-face discussion, a radio program, and a television program.

27. The system of claim 25, wherein the user profile information further includes a list of one or more words that have previously been searched by the user.

28. The system of claim 25, further comprising:
means for adding at least one word from the captured speech to the list of one or more words that have previously been detected in one or more previous captured speeches.

29. The system of claim 25, wherein the user profile information includes information about a user's occupation, education, or interests.

30. The system of claim 29, wherein selecting one or more words is also based on a list of keywords and an exclusion list that are defined based at least in part on one or more words that have previously been searched by one or more other users having profile information similar to the user profile information.

31. The system of claim 25, further comprising:
means for executing the search query in response to generating the search query; and
means for causing results of the search query to be displayed to the user,
wherein the results include information about at least one topic included in the captured speech.

32. The system of claim 31, wherein the results are displayed to the user in response to detecting that the captured speech has concluded.

33. A method comprising:
receiving audio data corresponding to a captured speech associated with a user;
based on the audio data, determining that the captured speech includes at least one word that has not been previously detected in one or more previously captured speeches associated with the user; and
in response to determining that the captured speech includes the at least one word, generating a search query that includes the at least one word.

34. The method of claim 33, further comprising:
causing results of the search query to be displayed to the user.
